(19) United States
(12) Patent Application Publication
(10) Pub. No.: US 2021/0201351 A1
(43) Pub. Date: Jul. 1, 2021

(54) METHODS AND APPARATUS FOR ELECTRONICALLY DETERMINING ITEMS TO ADVERTISE

(71) Applicant: Walmart Apollo, LLC, Bentonville, AR (US)

(72) Inventors: Kaushiki NAG, Sunnyvale, CA (US); Kannan ACHAN, Saratoga, CA (US); Shirpaa MANOHARAN, Sunnyvale, CA (US); Soumya WADHWA, Sunnyvale, CA (US); Surya YALLA, Santa Clara, CA (US); Swaminathan DURAISAMY, Milpitas, CA (US)

(21) Appl. No.: 16/730,514

(22) Filed: Dec. 30, 2019

(51) Int. Cl. G06Q 30/02; G06N 3/08; G06F 16/23; G06F 16/2455; G06N 3/04; G06F 16/2453

(52) U.S. Cl. CPC G06Q 30/0256; G06N 3/08; G06F 16/24534; G06F 16/24562; G06N 3/04; G06F 16/2379

(57) ABSTRACT

This application relates to apparatus and methods for automatically determining items to advertise, such as on a website, based on user search queries. In some examples, a computing device trains a machine learning process with user session data that identifies user search queries and related search context. The computing device may execute the trained machine learning process to determine one or more predicted items for each of a plurality of search queries. The predicted items may be stored in a database. The computing device may receive a request for recommended items to advertise in connection with a current user query. In response, the computing device determines items for the current user query based on the predicted items stored in the database. In some examples, the computing device determines additional items based on search queries similar to the current search query. Advertisements for the items may then be displayed.

### TECHNICAL FIELD

The disclosure relates generally to digital advertisements and, more specifically, to electronically determining and providing item advertisement recommendations.

### BACKGROUND

At least some websites, such as retailer websites, display item advertisements. The item advertisements may include an image of an item, and a price of the item. For example, a website may display item advertisements, and may further allow a customer to purchase the advertised items. Customers, however, may not be interested in some items advertised. For example, customers may not be interested in the type of item being advertised.

As a result, a retailer may lose sales of items to a customer. For example, the customer may not buy an item that, if advertised, the customer would have purchased. In some examples, the customer may purchase the item elsewhere, such as through another website. In addition, the customer may make additional purchases at the other website. As such, there are opportunities to address the advertisement of items to customers.

### SUMMARY

The embodiments described herein are directed to automatically determining and providing recommendations for items and services that can be advertised, for example, digital item, on a website. The embodiments may allow a person, such as a customer, to be presented with advertisements that may be more relevant to (e.g., likely to interest) the person. For example, the embodiments may allow the person to view advertisements that the person may be more interested in purchasing. As such, the embodiments may allow for an improved user experience with purchasing items on a website. In addition, because a person may now spend less time reviewing irrelevant advertisements, the person may have additional time to consider additional items for purchase. Moreover, the embodiments may allow a retailer to increase item advertisement conversions (e.g., an amount of advertised items sold). In addition to or instead of these example advantages, persons of ordinary skill in the art having the benefit of these disclosures may recognize and appreciate other advantages as well.

In accordance with various embodiments, exemplary systems may be implemented in any suitable hardware or hardware and software, such as in any suitable computing device. For example, in some embodiments, a computing device trains a machine learning process with user session data that identifies user search queries and related search context. The computing device may execute the trained machine learning process to determine one or more predicted items for each of a plurality of search queries. The predicted items may be stored in a database. The computing device may receive a request for recommended items in connection with a current user query. In response, the computing device determines items for the current user query based on the predicted items stored in the database. In some examples, the computing device determines additional items based on search queries similar to the current search query. Advertisements for the items may then be displayed.

In some embodiments, a computing device is configured to obtain session data identifying a plurality of search queries and corresponding context for a plurality of users, and determine a corresponding anchor item for each of the plurality of search queries based on the context corresponding to each of the plurality of search queries. The computing device may also be configured to determine at least one recommended item for each of the plurality of search queries based on each of the plurality of search queries and the corresponding anchor item. The computing device may be configured to store the at least one recommended item for each of the plurality of search queries and the corresponding anchor items in an item recommendation database

In some embodiments, a computing device is configured to receive, for an anchor item, a plurality of recommended items. The computing device may also be configured to determine a plurality of subsets, where each subset comprises at a portion of the plurality of recommended items. The computing device may further be configured to determine, for each subset of the plurality of subsets, a relevancy value between the anchor item and each of the recommended items of the subset. The computing device may also be configured to determine, for each subset of the plurality of subsets, a distance value between each of the recommended items of the subset. The computing device may further be configured to determine, for each subset of the plurality of subsets, a diversity value for the subset based on the relevancy value and the distance value corresponding to the subset. The computing device may be configured to determine a diversified subset of the plurality of subsets based on the diversity values for the plurality of subsets.

In some examples, the computing device is configured to receive current session data identifying a current search query (e.g., a real-time search query), and determine a first recommended item from the at least one recommended items stored in the item recommendation database based on the current search query.

In some examples, the computing device is configured to determine a user identification and a webpage context based on the current session data. The computing device may also be configured to determine a historic search query based on the user identification, and determine a relevance of the historic search query to the webpage context. The computing device may also be configured to determine a second recommended item from the at least one recommended items stored in the item recommendation database when the relevance is beyond (e.g., above) a threshold.

In some embodiments, a method is provided that includes obtaining session data identifying a plurality of search queries and corresponding context for a plurality of users, and determining a corresponding anchor item for each of the plurality of search queries based on the context corresponding to each of the plurality of search queries. The method may also include determining at least one recommended item for each of the plurality of search queries based on each of the plurality of search queries and the corresponding anchor item. The method may further include storing the at least one recommended item for each of the plurality of search queries and the corresponding anchor items in an item recommendation database.

In some examples, the method includes receiving current session data identifying a current search query, and determining a first recommended item from the at least one recommended items stored in the item recommendation database based on the current search query.

In some examples, the method includes determining a user identification and a webpage context based on the current session data. The method may also include determining a historic search query based on the user identification, and determining a relevance of the historic search query to the webpage context. The method may further include determining a second recommended item from the at least one recommended items stored in the item recommendation database when the relevance is beyond a threshold.

In yet other embodiments, a non-transitory computer readable medium has instructions stored thereon, where the instructions, when executed by at least one processor, cause a computing device to perform operations that include obtaining session data identifying a plurality of search queries and corresponding context for a plurality of users, and determining a corresponding anchor item for each of the plurality of search queries based on the context corresponding to each of the plurality of search queries. The operations may also include determining at least one recommended item for each of the plurality of search queries based on each of the plurality of search queries and the corresponding anchor item. The operations may further include storing the at least one recommended item for each of the plurality of search queries and the corresponding anchor items in an item recommendation database.

In some examples, the operations include receiving current session data identifying a current search query, and determining a first recommended item from the at least one recommended items stored in the item recommendation database based on the current search query.

In some examples, the operations include determining a user identification and a webpage context based on the current session data. The operations may also include determining a historic search query based on the user identification, and determining a relevance of the historic search query to the webpage context. The operations may further include determining a second recommended item from the at least one recommended items stored in the item recommendation database when the relevance is beyond a threshold.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an item recommendation system in accordance with some embodiments;

FIG. 2 is a block diagram of the item recommendation computing device of the item recommendation system of FIG. 1 in accordance with some embodiments;

FIG. 3 is a block diagram illustrating examples of various portions of the item recommendation system of FIG. 1 in accordance with some embodiments;

FIGS. 4A, 4B, and 4C illustrate more detailed views of the item recommendation computing device of FIG. 2 in accordance with some embodiments;

FIG. 5 is a flowchart of an example method that can be carried out by the item recommendation computing device of FIG. 2 in accordance with some embodiments;

FIG. 6 is a flowchart of an example another method that can be carried out by the item recommendation computing device of FIG. 2 in accordance with some embodiments;

FIGS. 7A and 7B are flowcharts of yet other example methods that can be carried out by the item recommendation computing device of FIG. 2 in accordance with some embodiments; and

FIG. 8 is a block diagram of a webpage illustrating advertised items in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

The embodiments described herein employ machine learning processes to determine items advertised to a customer on, for example, a website. The machine learning processes may operate on user queries (e.g., searches) performed by the customer to determine the items. For example, user queries may include real-time user queries, user queries during a same session, and user queries performed by the customer over a previous period of time (e.g., 3 days, a month, etc.). In some examples, a context is determined for the user queries. The context may include items viewed or clicked on in response to the user query (e.g., items viewed or clicked on a search results page in response to the user query). In some examples, a context may be determined for real-time user queries. Historical queries with the same or similar context as the context for the real-time query may then be determined. The machine learning processes may operate on user queries with a same or similar context.

In some examples, the machine learning processes may, alternately or additionally, be based on determining the context of a webpage being viewed by the customer. For example, the context of an item webpage (e.g., a webpage dedicated to an item) may be the item. In some examples, the context of a category webpage (e.g., a webpage dedicated to a category of items) is the category of the items being viewed. In some examples, if the user is on a cart webpage (e.g., an online cart webpage showing items added to an online shopping cart), the context of the webpage may be the items in the cart. By leveraging search contexts and/or page contexts, more suitable item recommendations for the customer may be generated, thereby resulting in higher conversion rates (e.g., rate based on number of times an advertised item is purchased).

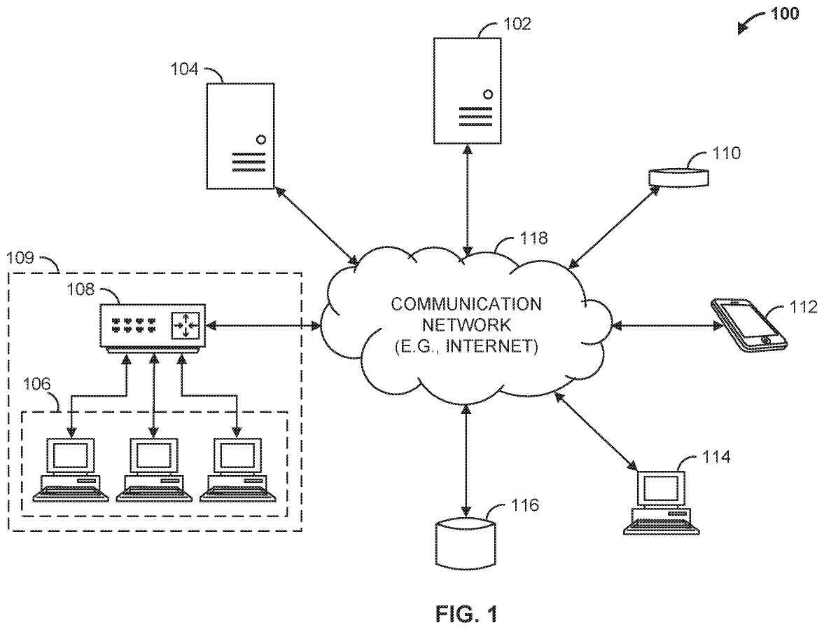

Turning to the drawings, FIG. 1 illustrates a block diagram of an item recommendation system 100 that includes an item recommendation computing device 102 (e.g., a server, such as an application server), a web server 104, workstation(s) 106, database 116, and multiple customer computing devices 110, 112, 114 operatively coupled over network 118. Item recommendation computing device 102, workstation(s) 106, server 104, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, item recommendation computing device 102 can be a computer, a workstation, a laptop, a server such as a cloud-based server, or any other suitable device. In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, item recommendation computing device 102 is operated by a retailer, and multiple customer computing devices 112, 114 are operated by customers of the retailer.

Although FIG. 1 illustrates three customer computing devices 110, 112, 114, item recommendation system 100 can include any number of customer computing devices 110, 112, 114. Similarly, item recommendation system 100 can include any number of workstation(s) 106, item recommendation computing devices 102, servers 104, and databases 116.

Workstation(s) 106 are operably coupled to communication network 118 via router (or switch) 108. Workstation(s) 106 and/or router 108 may be located at a store 109, for example. Workstation(s) 106 can communicate with item recommendation computing device 102 over communication network 118. The workstation(s) 106 may send data to, and receive data from, item recommendation computing device 102. For example, the workstation(s) 106 may transmit data related to an order purchased by a customer at store 109 to item recommendation computing device 102. In response, item recommendation computing device 102 may transmit an indication of one or more item advertisements to provide to the purchasing customer. For example, the item advertisements may be displayed on a receipt handed to the customer for the purchase order.

In some examples, web server 104 may host one or more web pages, such as a retailer's website. The website may allow a customer to view and purchase items. For example, the website may display advertisements for items that a customer may purchase on the website. In some examples, item recommendation computing device 102 may transmit one or more item advertisements to display on the website. For example, the item advertisements may be displayed on a checkout webpage, on a homepage, on an item webpage, or on a webpage dedicated to a category of the advertised item, such as when a customer is browsing that webpage.

In some examples, web server 104 transmits user transaction data to item recommendation computing device 102. User transaction data may identify, for example, purchase transactions (e.g., the purchase of items) on a website.

In some examples, web server 104 transmits user session data to item recommendation computing device 102. User session data may identify items viewed, engaged (e.g., clicked on), or purchased on a website. User session data may also identify, for example, item advertisement impressions, items added to an online shopping cart, or items purchased after an engagement on the website of an advertisement for the items. User session data may also identify any other data related to the browsing of a website.

First customer computing device 110, second customer computing device 112, and N^{th} customer computing device 114 may communicate with web server 104 over communication network 118. For example, each of multiple computing devices 110, 112, 114 may be operable to view, access, and interact with webpages of a website hosted by web server 104. In some examples, web server 104 hosts a website for a retailer that allows for the purchase of items. An operator of one of multiple computing devices 110, 112, 114 may access the website hosted by web server 104, add one or more items to an online shopping cart of the website, and perform an online checkout of the shopping cart to purchase the items.

Item recommendation computing device 102 is operable to communicate with database 116 over communication network 118. For example, item recommendation computing device 102 can store data to, and read data from, database 116. Database 116 can be a remote storage device, such as a cloud-based server, a memory device on another application server, a networked computer, or any other suitable remote storage. Although shown remote to item recommendation computing device 102, in some examples, database 116 can be a local storage device, such as a hard drive, a non-volatile memory, or a USB stick.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

In some examples, item recommendation computing device 102 trains a machine learning model, such as one based on recurrent neural networks (RNN), with user session data, such as user search events. User search events can include, for example, real-time or historical search queries, and user actions (e.g., clicks or views) based on user query search results. For example, user session data can identify a user identification (ID) for the customer, one or more search queries performed by the customer, and items engaged during the user session, such as items viewed, items added to an online cart, and/or items purchased by the customer.

For a given search query and item (e.g., anchor item), item recommendation computing device 102 may generate machine learning model training data (e.g., feature data) based on user session data for a plurality of customers. For example, the machine learning model training data may comprise training vectors, where each training vector identifies an anchor item, a search query, and any items viewed, items added to an online cart, and/or items purchased during the search query. Item recommendation computing device 102 may train the machine learning model with the machine learning model training data (e.g., training vectors).

In some examples, the machine learning model is trained until a determined error is below a threshold. For example, the machine learning model may output item embedding vectors, each item embedding identifying a predicted item (e.g., via an item ID). Item recommendation computing device 102 may determine whether the predicted item is the same as items associated with each user query (e.g., items viewed, clicked, purchased, etc.). Based on the determinations, item recommendation computing device 102 may generate an error value. For example, an error value of 0 may indicate that all predicted items were the same as (e.g., matched) the items associated with each user query, whereas an error value of 1 may indicate that no predicted items were the same. Item recommendation computing device 102 may train the machine learning model until the error value is below a threshold, such as 5%.

In some examples, during inference, the trained machine learning model obtains user session data for a customer. The user session data may identify, for example, a user search request, as well as items engaged during the user search request. Item recommendation computing device 102 may generate data identifying anchor item and user search query pairs. For each anchor item and user search query pair, item recommendation computing device 102 may determine a number of times the customer has executed similar queries over a previous period of time (e.g., a month, 60 days, etc.). Similar queries may be determined, for example, based on generating word embeddings, and comparing the word embeddings, between search queries, as described further below. If the customer has executed a threshold number (e.g., 7) of similar queries over the previous period of time, the anchor item and user search query pair is provided to the trained machine learning model to determine predicted items. The predicted items may then be stored in a database, such as database 116. In some examples, if the customer has not executed the threshold number of similar queries over the previous period of time, the user search query is not provided to the trained machine learning algorithm. In some examples, the predicted items are advertised, such as by web server 104, on a webpage viewed by the customer.

In some examples, for each predicted item, an embedding matrix of items (e.g., vector or matrix identifying item embeddings for each item) is employed to determine nearest neighbors (e.g., most similar items). For example, item recommendation computing device 102 may determine the nearest neighbors (e.g., approximate nearest neighbors) of each predicted item. In some examples, item recommendation computing device 102 generates an item embedding graph with the item embeddings, and stores the item embedding graph to memory, such as database 116. Item recommendation computing device 102 may then execute a search of the item embedding graph to determine the nearest neighbors to each predicted item (e.g., a nearest-neighbor search).

In some examples, the embedding matrix of items (e.g., item embedding graph) is trained for different distance metrics such as a cosine distance or Euclidean distance. A search request for nearest neighbor tries to return items which have embeddings nearest to the requested search item embedding. In some examples, a predetermined number of nearest neighbors are determined. The predetermined number may be configurable. The predicted item, and each of the nearest neighbors, may be stored in database 116.

In some examples, in response to a user search query, item recommendation computing device 102 may identify one or more of the predicted item and corresponding nearest neighbors. Item recommendation computing device 102 may provide the one or more predicted items and corresponding nearest neighbors to web server 104. Web server 104 may then display advertisements of the predicted item and nearest neighbors on a webpage associated with each corresponding anchor item, for example.

In some examples, item recommendation computing device 102 determines a number of most frequent search queries (e.g., over a period of time, such as a month, year, etc.). The most frequent search queries may be the search queries most often executed over the period of time. For each of the most frequent search queries, one or more item recommendations are determined based on executing the machine learning processes described herein. The item recommendations for each (e.g., type of) user search query may be stored in database 116, for example.

In some examples, a determination is made as to the number of most frequent search queries that account for a threshold percentage (e.g., 65%) of user activity (e.g., customer added an item to a cart, customer purchased the item, etc.). Only item recommendations for those number of most frequent search queries that account for the threshold percentage of user activity are stored in database 116. As for the number of most frequent search queries that are not part of the threshold percentage, a determination is made as to the closest most frequent search query that is part of the number of most frequent search queries. Each most frequent search query that is not part of the threshold percentage can be linked to (e.g., point to) at least one most frequent search query that is part of the threshold percentage. For example, rather than storing item recommendations for the most frequent search queries that are not part of the threshold percentage, each one will be associated with the item recommendations associated with the most frequent search queries that each one is linked to.

In some examples, each most frequent search query is normalized. To normalize the most frequent search queries, for each most frequent search query, a punctuation removal (e.g., deletion) process is performed to remove punctuation from the query. In some examples, stop words are also removed from the search query in accordance with known techniques. The resulting words may, in some examples, be then put through a stemming process to reduce inflections. In some examples, the processes of punctuation removal, stop word removal, and stemming may be performed in a different order.

In some examples, a machine learning algorithm, such as one based on GloVe, is trained with normalized user search queries, such as normalized historical user search queries. Once trained, GloVe embeddings are generated for each of the words of the most frequent search queries. A most frequent user search query representation can be generated based on the GloVe embeddings of each word for each most frequent search query. For example, a most frequent user search query vector can be generated for each most frequent user search query representation based on averaging the word embeddings of each most frequent user search query. In some examples, the most frequent user search query representations are indexed in database 116 to allow for faster searching. The most frequent indexed user search query representations may be considered candidate most frequent user search query representations. Each of the most frequent indexed user search query representations is associated with (e.g., include) one or more item recommendations that were determined based on executing the machine learning processes described herein.

In some examples, user session data (e.g., real-time user session data) for a customer is received. The user session data may identify a user search request (e.g., a real-time user search request), and a webpage context associated with the user search request. For example, for an item page, webpage context may include a webpage address, a product title, and a product category. For a category webpage, the context may include the category of the items being viewed. For a cart webpage, the context of the webpage may be the product titles of the items in the cart. Item recommendation computing device 102 may obtain historical search requests by the customer over a previous period of time (e.g., 30 days), assuming any are available. The user search request and/or historical search requests for the customer may be stemmed. Assuming at least one historical search query was retrieved, a relevance value for each historical search query is determined based on the webpage context. For example, the relevance scores may be determined based on Jaccard similarity scores. In some examples, the webpage context is for an item webpage (e.g., a webpage dedicated to an item), and the webpage context identifies a product title of the item and a category of the item. Item recommendation computing device 102 may determine the Jaccard similarity score between the words of the historical search query and the words describing the anchor product name (e.g., title) and/or the anchor product category.

Based on the relevancy scores, one or more of the historical search queries may be filtered out. For example, historical search queries without at least a threshold Jaccard similarity score (e.g., a minimum Jaccard similarity score) is filtered out (e.g., not used). For example, those queries for which the default thresholds are not met are removed from consideration. In some examples, the filtered queries are then ranked by Jaccard score with respect to the anchor's product name.

Item candidates may then be obtained from a database, such as database 116, based on the user search request, as well as on any historical search requests that were not filtered out. For example, the user search request may be normalized, and GloVe embeddings may be generated for the normalized words of the user search request. A user search query representation may then be generated based on the GloVe embeddings. In some examples, the GloVe embeddings for the words are averaged to generate the user search query representation. Similarly, historical user search query representations may be generated for any historical search requests that were not filtered out.

Item recommendations for each user search query representation and any historical user search query representations are determined based on the user search query representations stored in database 116. For example, the user search query representations stored in database 116 may be stored using a key-value configuration where each user search query representation acts as a “key” and the associated item recommendations are the “values.” Item recommendation computing device 102 may obtain the “values” for the “key” that corresponds to the user search query representation or historical user search query representation being serviced. As explained below, corresponding key may be determined using direct search query lookups and indirect search query lookups (e.g., closest to search query lookups).

A direct search query lookup may include an exact match between a user search query representation/historical user search query representation and a user search query representations stored in database 116. An indirect search query lookup may include determining the closest user search query representation stored in database 116 (e.g., a most frequent indexed user search query representation) to a user search query representation/historical user search query representation. Indirect search query lookups may be conducted by determining a number of closest queries to an input user search query.

For example, user search query representations stored in database 116 may include GloVe embeddings. For each user search query, embeddings are computed using average embeddings of constituent words. Embeddings for user search queries that have pre-determined item recommendations can be indexed for efficient search. The created index can then be used to retrieve a number of closest queries to an input user search query using, for example, cosine similarity between generated query embedding vectors employed as the distance metric. Further, in some examples, user search queries that are not associated with a same category and/or sub-category as that of the input user search query are filtered out.

In some examples, item recommendations associated with each direct and indirect search query lookup is provided. For example, item recommendations using direct search query lookups for the user search request may be obtained. In addition, item recommendations using direct search query lookup for any historical search requests may also be obtained. In some examples, item recommendations using indirect search query lookups for the user search request are obtained. In addition, item recommendations using indirect search query lookup for any historical search requests may also be obtained.

In some examples, a threshold number of item recommendations are provided. The threshold number of recommendations may be a preconfigured number. For example, item recommendations are obtained until the preconfigured number of item recommendations are obtains. In some examples, item recommendations using direct search query lookups for the user search request are first obtained. If the preconfigured number of item recommendations are not yet obtained, then item recommendations using indirect search query lookups for the user search request are obtained. If the preconfigured number of item recommendations are not yet obtained, then item recommendations using direct search query lookup for historical search requests may are obtained. If the preconfigured number of item recommendations are not yet obtained, then item recommendations using indirect search query lookup for historical search requests may are obtained.

In some examples, a category and/or a subcategory is assigned to each user search request and historical search request based on categories and/or sub-categories of items viewed, items added to an online cart, and/or items purchased during the corresponding search request. A category and/or subcategory of an item corresponding to the user search request. For example, the webpage context identified in the user session data may identify an anchor item, or a webpage of an anchor item. A category and/or sub-category of the anchor item may be determined (e.g., based on an item ID for the anchor item). In some examples, item recommendations are obtained only from search requests (e.g., user search request and corresponding historical search requests) with the same category and/or sub-category. This feature may assist in preventing item recommendations that are widely irrelevant or unrelated to the anchor item.

In some examples, the item recommendations are transmitted to web server 104 to display on a webpage, such as a retailer's webpage. In some examples, the items are displayed on a webpage dedicated to a corresponding anchor item. As an example, assume a customer executes a search on a retailer's webpage for “women's red boots,” and the webpage returns various results. Assume that the customer clicks on one of the search results. Item recommendation computing device 102 may receive user session data for the customer identifying the user search request and webpage context for the item clicked. Item recommendation computing device 102 may then determine up to the preconfigured number of item recommendations as described above. The item recommendations may be transmitted to web server 104. Web server 104 may display the item advertisements on the webpage dedicated to the item the customer clicked on.

As another example, assume a customer has searched for “brand X jeans” in the past, where the historical search query was stored in database 116. The customer now visits a webpage dedicated to brand X jeans on a retailer's website hosted by web server 104. Item recommendation computing device 102 may receive user session data identifying webpage context for the webpage dedicated to brand X jeans, and retrieves the historical search query for “brand X jeans” from database 116. Item recommendation computing device 102 may determine up to the preconfigured number of item recommendations based on the historical search query and webpage context as described above. The item recommendations may be transmitted to web server 104. Web server 104 may display advertisements for the item recommendations on the webpage being visited by the customer.

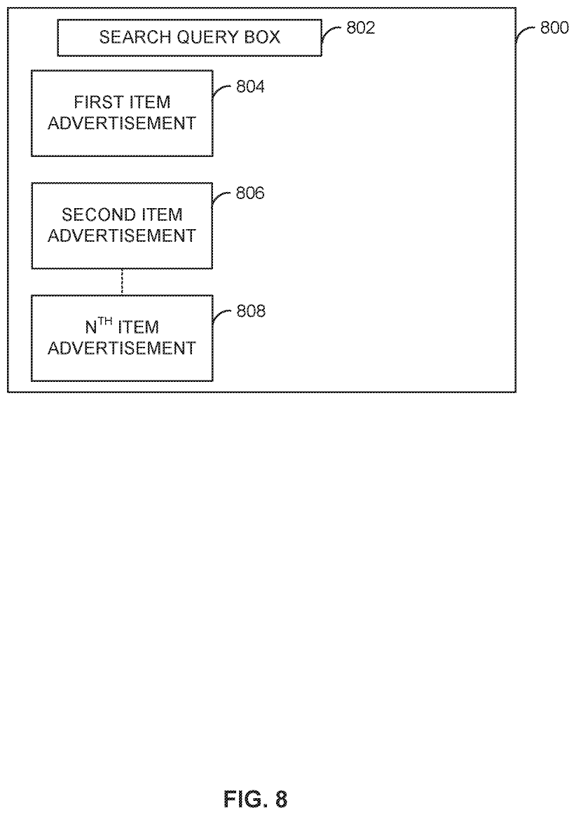

For example, FIG. 8 illustrates a webpage 800 that may be displayed by web server 104. Webpage 800 includes a search query box 802. A customer visiting webpage 800 may enter a search query in search query box 802, and web server 104 may transmit the search query to item recommendation computing device 102. In response, item recommendation computing device 102 may determine item recommendations based on the search query, and may transmit the item recommendations to web server 104. For example, the item recommendations may include a first item, a second item, and up to an N^{th} item. Web server 104 may then display item advertisements for the items. As illustrated, web server 104 may display first item advertisement 804, second item advertisement 806, and up to N^{th} item advertisement 808.

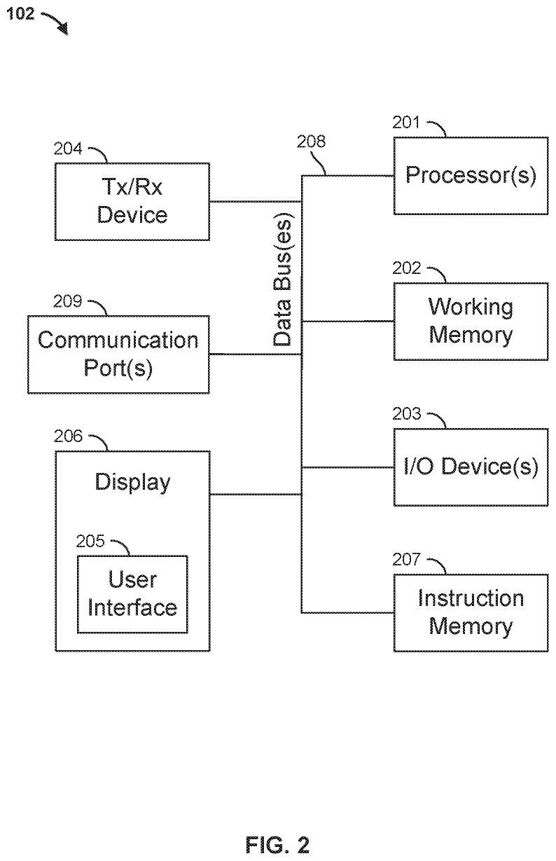

FIG. 2 illustrates the item recommendation computing device 102 of FIG. 1. Item recommendation computing device 102 can include one or more processors 201, working memory 202, one or more input/output devices 203, instruction memory 207, a transceiver 204, one or more communication ports 209, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of item recommendation computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as machine learning algorithm training data.

Display 206 can display user interface 205. User interfaces 205 can enable user interaction with item recommendation computing device 102. For example, user interface 205 can be a user interface for an application of a retailer that allows a customer to view and interact with a retailer's webpage. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 item recommendation computing device 102 will be operating in. Processor(s) 201 is operable to receive data from, or send data to, a network, such as communication network 118 of FIG. 1, via transceiver 204.

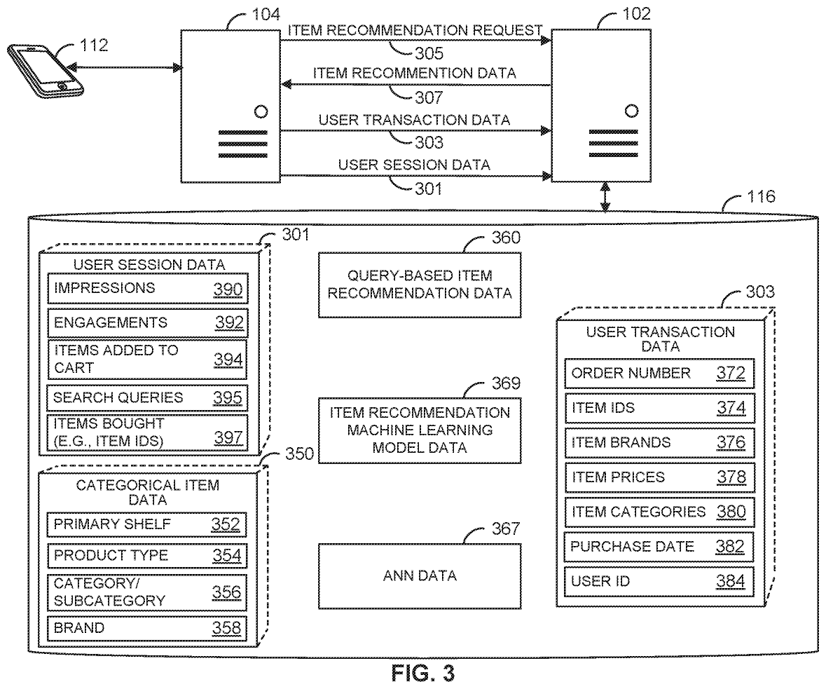

FIG. 3 is a block diagram illustrating examples of various portions of the item recommendation system 100 of FIG. 1. As indicated in the figure, item recommendation computing device 102 may receive user session data 301 and user transaction data 303 from web server 104 for each of a plurality of users (e.g., customers). User session data 301 may identify data associated with each browsing session (e.g., historical browsing sessions) of each user of the plurality of users. For example, user session data 301 may identify impressions 390 (e.g., items or item advertisements viewed), engagements 392 (e.g., item advertisements engaged), items added add to cart 394 (e.g., items added to online shopping carts), search queries 395 (e.g., historical search queries), items bought 397 (e.g., items purchased), and any other data related to website browsing sessions.

User transaction data 303 may identify any data related to the purchase of items, such as an order number 372, item identifications (IDs) 374, item brands 376, item prices 378, item categories 380, purchase dates 382, and user IDs 384 (e.g., the user ID of a customer making the purchase on the website). Item recommendation computing device 102 may store user session data 301 and user transaction data 303 in database 116.

Database 116 may also store categorical item data 350, which may identify attributes of each of a plurality of items, such as items sold on a retailer's website). For example, categorical item data 350 may include a primary shelf 352 for each item. The primary shelf of each item may be based on a taxonomical hierarchy that defines which category a product belongs to. For example, a primary shelf for brand “A” laptops may be: Electronics/Computers/Laptops/Brand A Laptops. Categorical item data 350 may also include a product type 354 of each item, a category and/or subcategory 356 of each item, and a brand 358 of each item. Item recommendation computing device 102 may employ categorical item data 350 to determine a similarity between a historical search query and webpage context, for example.

In this example, database 116 also stores item recommendation machine learning model data 369. Item recommendation machine learning model data 369 identifies and characterizes a machine learning model (e.g., algorithm), such as one based on RNN, that can identify item recommendations for advertisement based on search queries. Item recommendation computing device 102 may obtain (from database 116) and execute item recommendation machine learning model data 369. For example, item recommendation computing device 102 may provide the machine learning model with user search queries (e.g., historical search queries) and corresponding webpage context (e.g., anchor item and user query pair data) to generate item embedding vectors, each element of each item embedding vector identifying a predicted item.

In some examples, item recommendation computing device 102 determines nearest neighbors for each predicted item. For example, approximate nearest neighbor (ANN) data 367 may identify and characterize an embedding matrix of items (e.g., item embedding graph). Item recommendation computing device 102 may search ANN data 367 to determine the nearest neighbors of each predicted item. Item recommendation computing device 102 may generate query-based item recommendation data 360 identifying the predicted item and any nearest neighbors for each user query. In some examples, query-based item recommendation data 360 is a database identifying search queries and corresponding items. For example, each search query may identify one or more items (e.g., predicted items and nearest neighbors). The search queries may normalized, as described herein, and indexed accordingly. Query-based item recommendation data 360 may be stored in database 116, for example.

In some examples, item recommendation computing device 102 receives an item recommendation request 305 from web server 104 for a user that executes a search query on a webpage, such as a webpage dedicated to an item (e.g., an anchor item page), displayed by web server 104. Item recommendation request 305 may include one or more of a user ID associated with the user, the current user search query, a webpage context for a webpage engaged (e.g., being viewed, or clicked) by the user, and a number of requested item recommendations. In response to receiving item recommendation request 305, item recommendation computing device 102 may determine one or more predicted items and nearest neighbors based on query-based item recommendation data 360.

For example, item recommendation computing device 102 may obtain historic search queries for the user (e.g., based on the user ID), and stem the current user search query and historic search queries. Item recommendation computing device 102 may then determine relevance scores between each of the stemmed historic search queries for the user and the webpage context. The stemmed historic search queries may be filtered based on the relevance scores. For example, stemmed historic search queries with relevance scores indicating relevance beyond (e.g., below) a threshold may be filtered out (e.g., removed). Item recommendation computing device 102 may then obtain item recommendations from query-based item recommendation data 360 based on the stemmed current user search query and any remaining stemmed historic search queries. Item recommendation computing device 102 may generate item recommendation data 307 identifying the item recommendations, and may transmit item recommendation data 307 to web server 104.

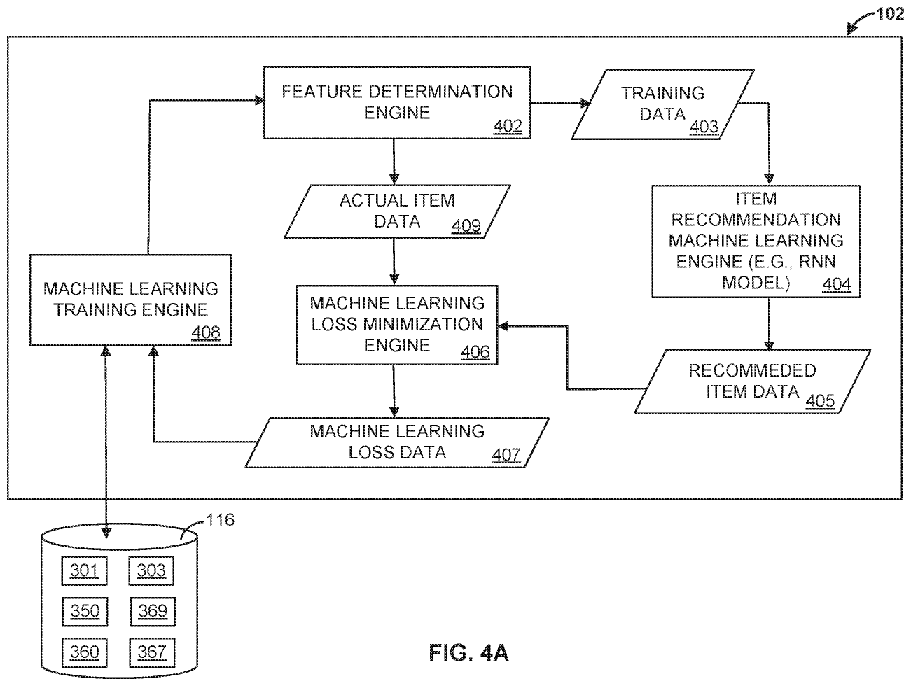

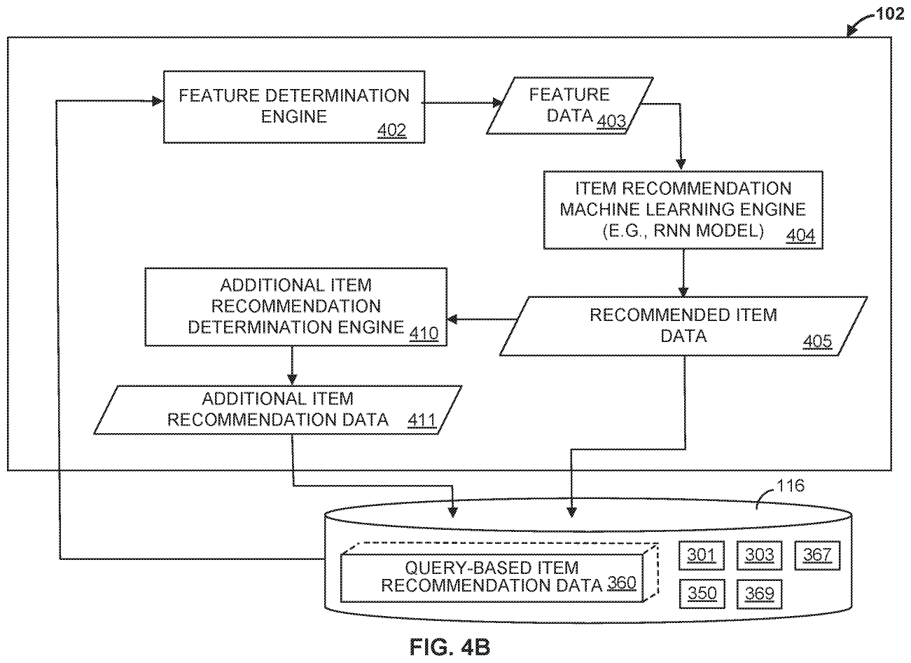

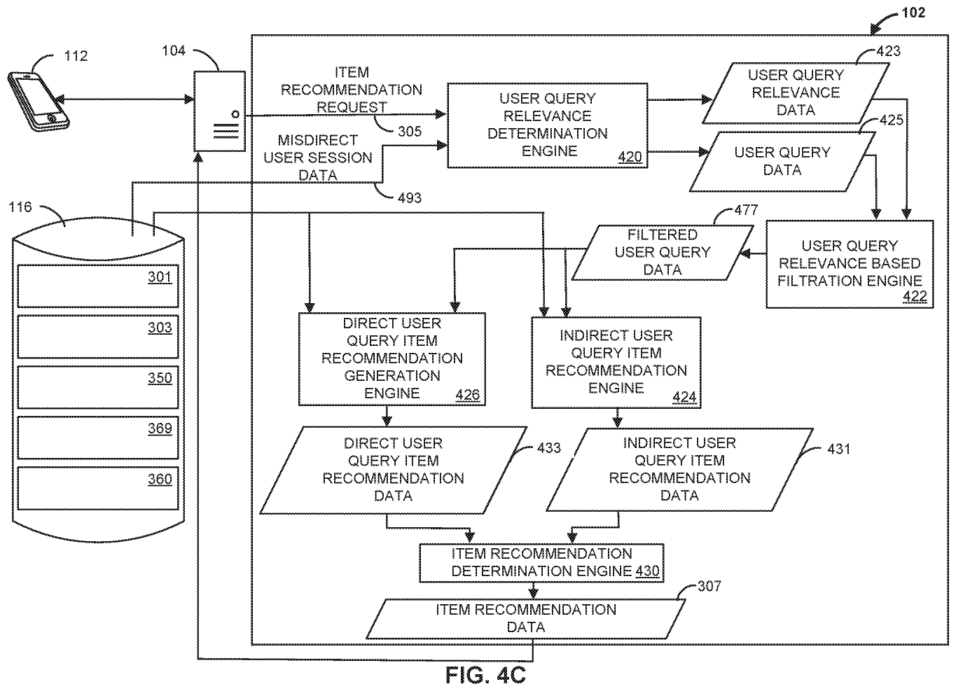

FIGS. 4A, 4B, and 4C illustrate more detailed views of the item recommendation computing device 102 of FIG. 2. As illustrated in FIG. 4A, item recommendation computing device 102 includes feature determination engine 402, item recommendation machine learning engine 404, machine learning loss minimization engine 406, and machine learning training engine 408. Referring to FIG. 4B, item recommendation computing device 102 may also include additional item recommendation determination engine 410. As illustrated in FIG. 4C, item recommendation computing device 102 may include relevance determination engine 420, user query relevance based filtration engine 422, indirect user query item recommendation engine 424, direct item recommendation generation engine 426, and item recommendation determination engine 430.

In some examples, one or more of feature determination engine 402, item recommendation machine learning engine 404, machine learning loss minimization engine 406, machine learning training engine 408, additional item recommendation determination engine 410, relevance determination engine 420, user query relevance based filtration engine 422, indirect user query item recommendation engine 424, direct item recommendation generation engine 426, and item recommendation determination engine 430 may be implemented in hardware.

In some examples, one or more of feature determination engine 402, item recommendation machine learning engine 404, machine learning loss minimization engine 406, machine learning training engine 408, additional item recommendation determination engine 410, relevance determination engine 420, user query relevance based filtration engine 422, indirect user query item recommendation engine 424, direct item recommendation generation engine 426, and item recommendation determination engine 430 may be implemented as an executable program maintained in a tangible, non-transitory memory, such as instruction memory 207 of FIG. 2, which may be executed by one or processors, such as processor 201 of FIG. 2.

Referring back to FIG. 4A, machine learning training engine 408, feature determination engine 402, item recommendation machine learning engine 404, and machine learning loss minimization engine 406 may be configured to train a machine learning process executed by item recommendation machine learning engine 404.

In this example, machine learning training engine 408 obtains user session data 301 that is to be used for training the machine learning process. The obtained user session data 301 identifies training user queries as well as training user webpage events (e.g., engagements, items added to cart, items bought, etc.), from database 116. Machine learning training engine 408 may package the user session data 301 for transmission to feature determination engine 402. Feature determination engine 402 may generate training data 403 (e.g., vector data) based on the obtained user session data 301. The training data 403 identifies, for each of a plurality of training data elements, an anchor item, a search query, and any items viewed, items added to an online cart, and/or items purchased during the corresponding search query. Feature determination engine 402 may package the training data 403 into a format expected by the machine learning model executed by item recommendation machine learning engine 404. Feature determination engine 402 may also generate actual item data 409, which identifies actual items engaged (e.g., viewed, clicked, etc.), as identified by the user webpage events, and provide actual item data 409 to machine learning loss minimization engine 406.

Item recommendation machine learning engine 404 may execute a machine learning model (e.g., algorithm), such as one identified and characterized by item recommendation machine learning model data 369 stored in database 116. Item recommendation machine learning engine 404 may provide to the machine learning model, as input, the training data 403 received from feature determination engine 402, to train the machine learning model. Based on execution of the machine learning model, item recommendation machine learning engine 404 may generate recommended item data 405, which identifies one or more predicted items for each training data element identified by training data 403. Recommended item data 405 may identify and characterize item embedding vectors, for example.

Machine learning loss minimization engine 406 may compare recommended item data 405 to actual item data 409 to generate machine learning loss data 407. Machine learning loss data 407 may identify error values based on the comparison between recommended item data 405 to actual item data 409. In some examples, machine learning loss data 407 identifies an average error (e.g., based on multiple comparisons). Machine learning loss minimization engine 406 may transmit machine learning loss data 407 to machine learning training engine 408.

Machine learning training engine 408 may determine whether to continue the training of the machine learning model based on machine learning loss data 407. For example, once the machine learning loss data 407 indicates an error value (or error values) beyond a threshold (e.g., below a minimum threshold), machine learning training engine 408 may complete the training of the machine learning model. Otherwise, if machine learning loss data 407 indicates that the error value (or error values) are not beyond the threshold, machine learning training engine 408 may continue training the machine learning model.

FIG. 4B illustrates the generation of query-based item recommendation data 360 based on executing the trained machine learning model. For example, feature determination engine 402 may generate feature data 423 (e.g., embedding vectors) based on user session data 301 (e.g., including historical user queries) obtained from database 116. The feature data 403 can identify a plurality of embedding vectors, each embedding vector identifying an anchor item, a search query, and any items viewed, items added to an online cart, and/or items purchased during the corresponding search query. Feature determination engine 402 may package the embedding vectors into a format expected by the trained machine learning model executed by item recommendation machine learning engine 404.

Item recommendation machine learning engine 404 may execute the trained machine learning model to generate recommended item data 405, which identifies one or more predicted items. Each predicted item may be an item that is recommended to be advertised on a webpage dedicated to the corresponding anchor item, for example. Item recommendation machine learning engine 404 may provide recommended item data 405 to additional item recommendation determination engine 410.

Additional item recommendation determination engine 410 may determine items similar to those identified by item recommendation data 405. For example, additional item recommendation determination engine 410 may determine nearest neighbors of each predicted item identified by item recommendation data 405 by searching ANN data 367 for the nearest neighbors.

Recommended item data 405 and additional item recommendation data 411 may be stored as query-based item recommendation data 360 in database 116. For example, query-based item recommendation data 360 may be stored such that each predicted item (e.g., as identified by recommended item data 405) is linked (e.g., via a pointer) to any corresponding additional items (as identified by additional item recommendation data 411).

Referring to FIG. 4C, during a current user session 495, web server 104 transmits an item recommendation request 305 to item recommendation computing device 102, which is provided to user query relevance determination engine 420. Item recommendation request 305 may identify a user ID associated with the user, a current user search query, and a webpage context for a webpage engaged by the user.

User query relevance determination engine 420 may also obtain historic user session data 493 for the user from database 116. For example, user query relevance determination engine 420 may obtain search queries 395 from user session data 301 for the user associated with the user ID received in item recommendation request 305. Historic user session data 493 may identify, for example, historic user search queries over a predetermined previous period of time (e.g., for the past 30 days).

User query relevance determination engine 420, in some examples, normalizes the current user search query and any obtained historic user search queries for the user. For example, user query relevance determination engine 420 may remove punctuation and stop words from each search query, and stem each search query, to generate normalized search queries (i.e., normalized current user search query and normalized historic user search queries). User query relevance determination engine 420 may generate user query data 424 identifying each (normalized) historic user search query and the current user search query.

User query relevance determination engine 420 may determine a relevance of each (normalized) historic user search query. For example, user query relevance determination engine 420 may determine a relevance value for each historical search query based on Jaccard similarity scores between each historical search query and the webpage context identified by item recommendation request 305. User query relevance determination engine 420 may generate user query relevance data 423 identifying the relevance of each historical user search query.

In some examples, relevance determination engine 420 determines a category and/or a subcategory associated with the webpage context identified in item recommendation request 305. For example, the webpage context may identify an item ID of an anchor item, and relevance determination engine 420 may determine a category and/or subcategory of the anchor item (e.g., based on categorical item data 350 stored in database 116). Relevance determination engine 420 may also determine a category and/or subcategory for the current user search query and any obtained historic user search queries based on categories and/or sub-categories of and items viewed, items added to an online cart, and/or items purchased during the corresponding user search query. Relevance determination engine 420 may filter out any user search queries that do not have a same category and/or subcategory associated with the webpage context.

User query relevance based filtration engine 422 may receive user query relevance data 423 and user query data 425 from user query relevance determination engine 420. User query relevance based filtration engine 422 may filter out (e.g., remove) historical user search queries based on their corresponding relevance (e.g., relevance scores) identified by user query relevance data 423. For example, user query relevance based filtration engine 422 may filter out any historical user search queries with a corresponding relevance that is beyond (e.g., below) a threshold. User query relevance based filtration engine 422 generates filtered user query data 477 identifying and characterizing any remaining historical user search queries and the current user search query.

Direct user query item recommendation generation engine 426 can determine items recommended to be advertised by executing direct search query lookups based on filtered user query data 477. For example, direct user query item recommendation generation engine 426 may execute a direct search query lookup of query-based item recommendation data 360 based on the current user search query identified by filtered user query data 477 to determine recommended items. Similarly, direct user query item recommendation generation engine 426 may execute a direct search query lookup of query-based item recommendation data 360 based on the historical user search queries identified by filtered user query data 477 to determine additional recommended items. Direct user query item recommendation generation engine 426 may generate direct user query item recommendation data 433 identifying and characterizing the recommended items determined.

Indirect user query item recommendation engine 424 can determine items recommended to be advertised by executing indirect search query lookups based on filtered user query data 477. For example, indirect user query item recommendation generation engine 424 may execute an indirect search query lookup of query-based item recommendation data 360 based on the current user search query identified by filtered user query data 477 to determine recommended items. Similarly, indirect user query item recommendation generation engine 424 may execute an indirect search query lookup of query-based item recommendation data 360 based on the historical user search queries identified by filtered user query data 477 to determine additional recommended items. Indirect user query item recommendation generation engine 424 may generate indirect user query item recommendation data 431 identifying and characterizing the recommended items determined.

Item recommendation determination engine 430 obtains direct user query item recommendation data 433 from direct user query item recommendation generation engine 426, and indirect user query item recommendation data 431 from indirect user query item recommendation generation engine 424. Based on direct user query item recommendation data 433 and indirect user query item recommendation data 431, item recommendation determination engine 430 generates item recommendation data 307 identifying the recommended items to advertise. For example, item recommendation determination engine 430 may determine a preconfigured number of items to advertise based on items identified in direct user query item recommendation data 433 and indirect user query item recommendation data 431.

In some examples, item recommendation determination engine 430 obtains item recommendations, up to the preconfigured number, from direct user query item recommendation data 433 for the current user search query. If the preconfigured number of item recommendations are not yet obtained, then item recommendation determination engine 430 obtains item recommendations, up to the preconfigured number, from indirect user query item recommendation data 431 for the current user search query.

If the preconfigured number of item recommendations are not yet obtained, then item recommendation determination engine 430 obtains item recommendations, up to the preconfigured number, from direct user query item recommendation data 433 for the historical user search queries. If the preconfigured number of item recommendations are not yet obtained, then item recommendation determination engine 430 obtains item recommendations, up to the preconfigured number, from indirect user query item recommendation data 431 for the historical user search queries

Item recommendation determination engine 430 generates item recommendation data 307 identifying the recommended items to advertise, and transmits item recommendation data 307 to web server 104.

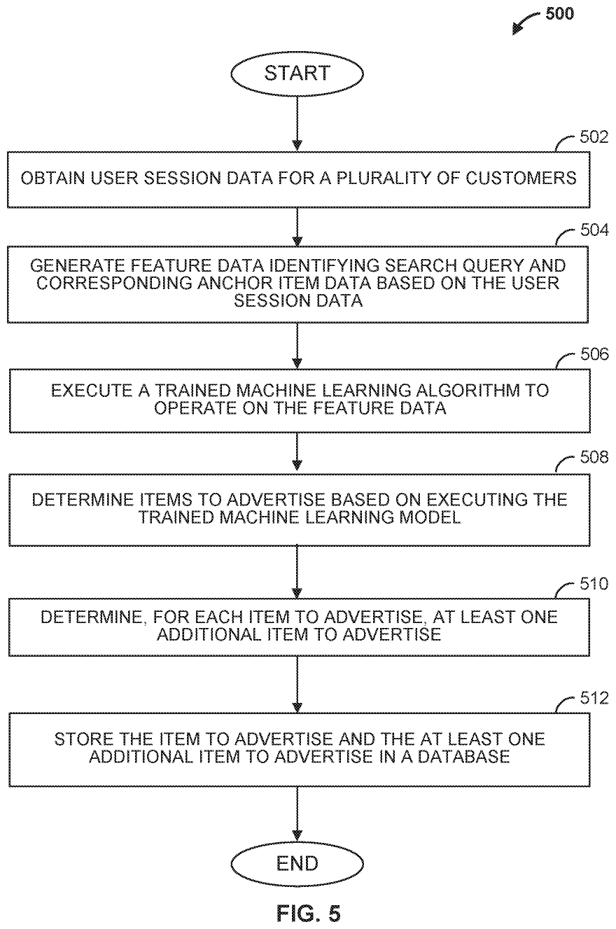

FIG. 5 is a flowchart of an example method 500 that can be carried out by the item recommendation system 100 of FIG. 1. Beginning at step 502, user session data for a plurality of customers is obtained. For example, item recommendation computing device 102 may obtain user session data 301 for a plurality of customers from database 116. At step 504, feature data is generated based on the user session data. The feature data identifies search query and corresponding anchor item data. For example, item recommendation computing device 102 may parse and extract from the user session data search queries, and webpage context data. Item recommendation computing device 102 may determine the anchor item based on the webpage context data (e.g., where the webpage is dedicated to the anchor item). In some examples, the feature data identifies search query and anchor item pairs. The feature data may be formatted for proper input to a machine learning algorithm.

Proceeding to step 506, a trained machine learning model is executed to operate on the feature data. The machine learning model may have been trained with search query and corresponding anchor item data. The machine learning model may be based on an RNN model. At step 508, items to advertise are determined based on the execution of the trained machine learning model. For example, an output of the trained machine learning algorithm may identify predicted items based on the feature data.

At step 510, for each determined item to advertise, at least one additional item to advertise is determined. For example, a nearest neighbor to each predicted item may be determined based on execution of an ANN. In some examples, all nearest neighbors within a threshold distance to the predicted item are determined.

Proceeding to step 512, the items to advertise and corresponding additional items are stored in a database. For example, item recommendation computing device 102 may store an identification of the items as query-based item recommendation data 360 in database 116. The method then ends.

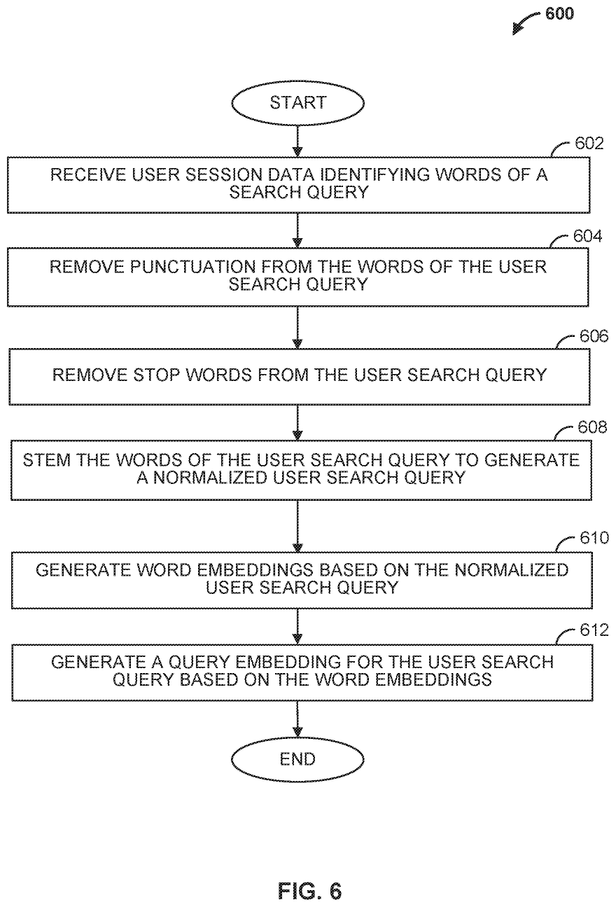

FIG. 6 is a flowchart of an example method 600 that can be carried out by the item recommendation system 100 of FIG. 1. Beginning at step 602, user session data identifying words of a search query are received. For example, item recommendation computing device 102 may receive from web server 104 user session data 301 identifying a current (e.g., real-time) search query conducted by a customer on a webpage of a retailer's website. At step 604, punctuation is removed from the words of the search query. At step 606, stop words are removed from the search query. At step 608, the remaining words are stemmed, thereby generating a normalized user search query.

Proceeding to step 610, word embeddings are generated based on the normalized user search query. For example, item recommendation computing device 102 may generate a GloVe embedding for each word of the normalized user search query. At step 612, a query embedding for the user search query is generated based on the word embeddings. For example, the query embedding may be based on averaging the word embeddings. In some examples, a predicted item is determined based on executing a trained machine learning model. The query embedding and predicted item may be stored as query-based item recommendation data 360 in database 116. The method then ends.

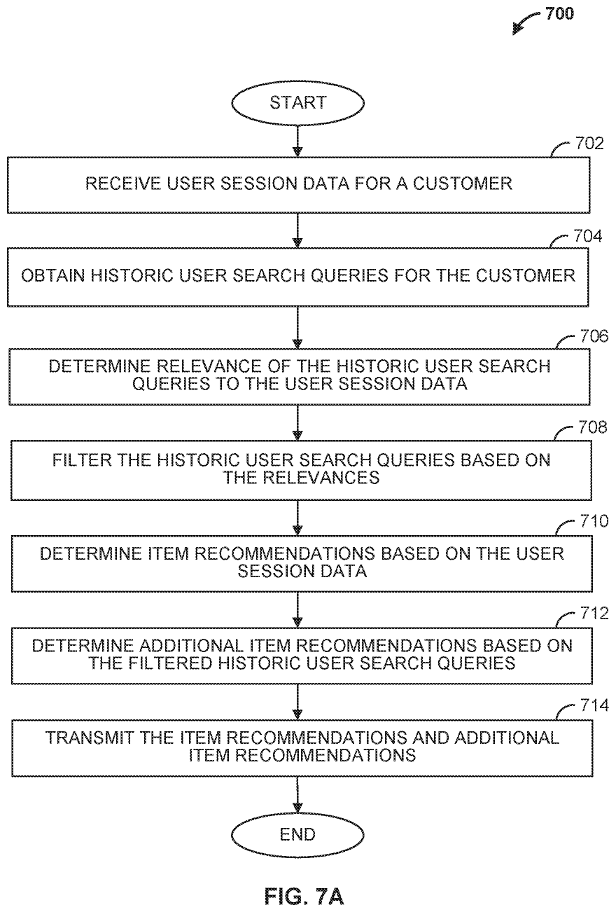

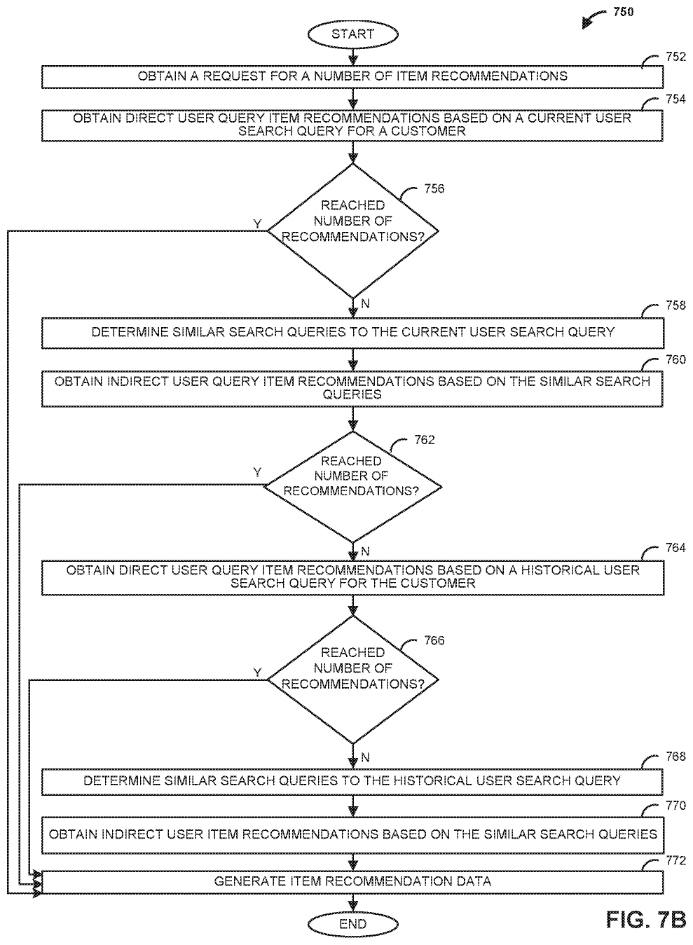

FIG. 7A is a flowchart of an example method 700 that can be carried out by the item recommendation system 100 of FIG. 1. Beginning at step 702, user session data is received for a customer. The user session data may identify a user search query, and context for the user search query (e.g., webpage context), for example. At step 704, historic user search queries are obtained for the customer. For example, item recommendation computing device 102 may determine a user ID 384 of the customer based on the user session data, and obtain historic user search queries for the customer from database 116 based on the user ID 384.

Proceeding to step 706, relevance of the historic user search queries to the user session data is determined. For example, item recommendation computing device 102 may determine Jaccard similarity scores based on each historic user search query and webpage context identified by the user session data. At step 708, the historic user search queries are filtered based on the relevancies determined in step 706. For example, historic user search queries with a relevancy below a threshold may be discarded.

Continuing to step 710, item recommendations are determined based on the user session data. For example, item recommendation computing device 102 may determine an item recommendation based on searching query-based item recommendation data 360 for the user search query identified by the user session data. At step 712, additional item recommendations are determined based on the filtered historic user search queries. For example, item recommendation computing device 102 may determine additional item recommendations based on searching query-based item recommendation data 360 for the historic user search queries.

Proceeding to step 714, the item recommendations and additional item recommendations are transmitted. For example, item recommendation computing device 102 may transmit the item recommendations and additional item recommendations to web server 104. Web server 104 may then display advertisements for the item recommendations and additional item recommendations. The method then ends.

FIG. 7B is a flowchart of an example method 750 that can be carried out by the item recommendation system 100 of FIG. 1. At step 752, a request for a number of item recommendations is obtained. For example, item recommendation computing device 102 may receive item recommendation request 305 identifying the number of item recommendations requested. At step 754, direct user query item recommendations are obtained based on a current user search query for a customer. For example, item recommendation request 305 may identify a current user search query. Item recommendation computing device 102 may execute a direct search query lookup of query-based item recommendation data 360 based on the current user search query to obtain the item recommendations. At step 756, a determination is made as to whether the number of requested item recommendations has been reached. If the number of requested item recommendations has been reached, the method proceeds to step 772. Otherwise, if the number of requested item recommendations has not been reached, the method proceeds to step 758.

At step 758, one or more similar search queries to the current user search query is determined. For example, item recommendation computing device 102 may determine the closest search queries to the current user search query. At step 760, indirect user query item recommendations are obtained based on the similar search queries. For example, item recommendation computing device 102 may execute an indirect search query lookup of query-based item recommendation data 360 based on the similar search queries to obtain the item recommendations. At step 762, a determination is made as to whether the number of requested item recommendations has been reached. If the number of requested item recommendations has been reached, the method proceeds to step 772. Otherwise, if the number of requested item recommendations has not been reached, the method proceeds to step 764.

At step 764, direct user query item recommendations are obtained based on a historical user search query for a customer. For example, item recommendation computing device 102 may determine a historical user search query for the customer based on, for example, a received user ID. The historical user search query may be obtained from user session data 301 stored in database 116, for example. Item recommendation computing device 102 may execute a direct search query lookup of query-based item recommendation data 360 based on the historical user search query to obtain the item recommendations. At step 766, a determination is made as to whether the number of requested item recommendations has been reached. If the number of requested item recommendations has been reached, the method proceeds to step 772. Otherwise, if the number of requested item recommendations has not been reached, the method proceeds to step 768.

At step 768, one or more similar search queries to the historical user search queries are determined. For example, item recommendation computing device 102 may determine the closest search queries to the historical user search queries. At step 770, indirect user query item recommendations are obtained based on the similar search queries. For example, item recommendation computing device 102 may execute an indirect search query lookup of query-based item recommendation data 360 based on the similar search queries to obtain the item recommendations. From step 770, the method proceeds to step 772.

At step 772, item recommendation data is generated based on the obtained item recommendations. For example, item recommendation computing device 102 may generate item recommendation data 307 identifying up to the number of requested item recommendations. Item recommendation computing device 102 may transmit the item recommendation data 307, such as to web server 104. Web server 104 may display advertisements for the items identified by the item recommendation data. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
obtain session data identifying a plurality of search queries and corresponding context for a plurality of users;
determine a corresponding anchor item for each of the plurality of search queries based on the context corresponding to each of the plurality of search queries;
determine at least one recommended item for each of the plurality of search queries based on each of the plurality of search queries and the corresponding anchor item; and
store the at least one recommended item for each of the plurality of search queries and the corresponding anchor items in an item recommendation database.

2. The system of claim 1, wherein determining the at least one recommended item for each of the plurality of search queries comprises executing a trained machine learning model to generate the at least one recommended item based on each of the plurality of search queries and the corresponding anchor item.

3. The system of claim 2, wherein the trained machine learning model is trained with training data identifying search query and anchor item pairs.

4. The system of claim 1, wherein the computing device is configured to:
generate an embedding for each of the at least one recommended items;
determine at least one additional recommended item for each of the at least one recommended items based on the embeddings; and
store the at least one additional recommended item for each of the at least one recommended items in the item recommendation database.

5. The system of claim 4, wherein generating the embedding for each of the at least one recommended items comprises executing an artificial neural network.

6. The system of claim 1, wherein the computing device is configured to determine a plurality of most frequent search queries of the plurality of search queries, wherein storing the at least one recommended item for each of the plurality of search queries and the corresponding anchor items in the item recommendation database comprises:
determining, for each of the plurality of search queries that is not in the plurality of most frequent search queries, a closest query of the plurality of most frequent search queries; and
storing a pointer to the closest query of the plurality of most frequent search queries instead of the at least one recommended item.

7. The system of claim 1, wherein the computing device is configured to:
receive current session data identifying a current search query; and
determine a first recommended item from the at least one recommended items stored in the item recommendation database based on the current search query.

8. The system of claim 7, wherein the current search query comprises a plurality of words, and wherein the computing device is configured to normalize the current search query by:
removing punctuation from the plurality of words;
removing stop words from the plurality of words; and
stemming the plurality of words, wherein determining the first recommended item from the at least one recommended items stored in the item recommendation database is based on the normalized current search query.

9. The system of claim 1, wherein storing the at least one recommended item for each of the plurality of search queries and the corresponding anchor items in the item recommendation database comprises:
generating a first plurality of word embeddings corresponding to each of the plurality of search queries;
generating a first query embedding based on the first plurality of word embeddings corresponding to each of the plurality of search queries; and
storing the first query embedding for each of the plurality of search queries in the item recommendation database.

10. The system of claim 9, wherein the computing device is configured to:
receive current session data identifying a current search query;
generate a second plurality of word embeddings based on the current search query;
generate a second query embedding based on the second plurality of word embeddings; and
determine a first recommended item from the at least one recommended items stored in the item recommendation database based on comparing the second query embedding to at least a portion of the first query embeddings for the plurality of search queries stored in the item recommendation database.

11. The system of claim 10, wherein the computing device is configured to:
determine a user identification and a webpage context based on the current session data;
determine a historic search query based on the user identification;
determine a relevance of the historic search query to the webpage context; and
determine a second recommended item from the at least one recommended items stored in the item recommendation database when the relevance is beyond a threshold.

12. A method comprising:
obtaining session data identifying a plurality of search queries and corresponding context for a plurality of users;
determining a corresponding anchor item for each of the plurality of search queries based on the context corresponding to each of the plurality of search queries;
determining at least one recommended item for each of the plurality of search queries based on each of the plurality of search queries and the corresponding anchor item; and
storing the at least one recommended item for each of the plurality of search queries and the corresponding anchor items in an item recommendation database.

13. The method of claim 12 wherein determining the at least one recommended item for each of the plurality of search queries comprises executing a trained machine learning model to generate the at least one recommended item based on each of the plurality of search queries and the corresponding anchor item.

14. The method of claim 13 wherein the trained machine learning model is trained with training data identifying search query and anchor item pairs.

15. The method of claim 12 comprising:
generating an embedding for each of the at least one recommended items;
determining at least one additional recommended item for each of the at least one recommended items based on the embeddings; and
storing the at least one additional recommended item for each of the at least one recommended items in the item recommendation database.

16. The method of claim 12 comprising:
receiving current session data identifying a current search query; and
determining a first recommended item from the at least one recommended items stored in the item recommendation database based on the current search query.

17. The method of claim 12 wherein storing the at least one recommended item for each of the plurality of search queries and the corresponding anchor items in the item recommendation database comprises:
generating a first plurality of word embeddings corresponding to each of the plurality of search queries;
generating a first query embedding based on the first plurality of word embeddings corresponding to each of the plurality of search queries; and
storing the first query embedding for each of the plurality of search queries in the item recommendation database.

18. A non-transitory computer readable medium having instructions stored thereon, wherein the instructions, when executed by at least one processor, cause a device to perform operations comprising:
obtaining session data identifying a plurality of search queries and corresponding context for a plurality of users;
determining a corresponding anchor item for each of the plurality of search queries based on the context corresponding to each of the plurality of search queries;
determining at least one recommended item for each of the plurality of search queries based on each of the plurality of search queries and the corresponding anchor item; and
storing the at least one recommended item for each of the plurality of search queries and the corresponding anchor items in an item recommendation database.

19. The non-transitory computer readable medium of claim 18 wherein determining the at least one recommended item for each of the plurality of search queries comprises executing a trained machine learning model to generate the at least one recommended item based on each of the plurality of search queries and the corresponding anchor item.

20. The non-transitory computer readable medium of claim 18 having additional instructions stored thereon, wherein the additional instructions, when executed by the at least one processor, cause the device to perform additional operations comprising:
receiving current session data identifying a current search query; and
determining a first recommended item from the at least one recommended items stored in the item recommendation database based on the current search query.
